(19) United States
(12) Patent Application Publication
(10) Pub. No.: US 2026/0106844 A1
(43) Pub. Date: Apr. 16, 2026

(54) SYSTEM AND METHODS FOR ADAPTIVE ENUMERATION OF PCIe DEVICES

(71) Applicant: Microchip Technology Incorporated, Chandler, AZ (US)

(72) Inventors: Prasanna Vengateshan Varadharajan, Chennai (IN); Vigneshraja Pannerselvam, Tamilnadu (IN); Atish Ghosh, Austin, TX (US); Pragash Mangalapandian, Chennai (IN)

(73) Assignee: Microchip Technology Incorporated, Chandler, AZ (US)

(21) Appl. No.: 19/045,652

(22) Filed: Feb. 5, 2025

(30) Foreign Application Priority Data
Oct. 11, 2024 (IN) 202411077364

(51) Int. Cl. H04L 49/111; H04L 41/0866

(52) U.S. Cl. CPC H04L 49/111; H04L 41/0866

(57) ABSTRACT

A system includes a PCIe switch coupled to one or more hosts and coupled to one or more external components. The PCIe switch includes an adaptive enumeration controller. The PCIe switch may read first configuration information from the one or more external components and may compare the first configuration information with second configuration information stored in the PCIe switch. Based on the results of the comparison, the adaptive enumeration controller may allow communication between the one or more hosts and the one or more external components or may prevent communication between the one or more hosts and the one or more external components or may modify communication between the one or more hosts and the one or more external components.

### PRIORITY

This application claims priority to commonly owned Indian Provisional Patent Application No. 202411077364 filed Oct. 1, 2024, the entire contents of which are hereby incorporated by reference for all purposes.

### FIELD OF THE INVENTION

The present disclosure relates to a system and method for adaptive enumeration of PCIe devices based on a configuration information.

### BACKGROUND

Enumeration of PCIe devices is a process used to identify and configure devices connected to a PCIe bus. As new hardware devices are connected to a PCIe bus, a host may enumerate the devices connected to the bus and may enable communication between host and devices on the bus. This process may be utilized by the system to recognize the hardware components and allocate resources such as memory and I/O ports.

In existing solutions, modifying the enumeration process may include significant modifications of software in a host or may include other custom system modifications.

There is a need for systems and methods to implement an adaptive enumeration to allow a PCIe switch to control configuration of devices and to control access to the PCIe bus without requiring changes to host software or to switch hardware.

### SUMMARY

The examples herein enable a system and method for adaptive enumeration of devices coupled to a PCIe bus.

According to one aspect, a system includes a PCIe switch coupled to a plurality of hosts. The PCIe switch includes a plurality of partitions, respective partitions comprising at least one upstream port and at least one downstream port. The system may include an adaptive enumeration controller coupled to the plurality of partitions, the adaptive enumeration controller comprising a memory, a rules table and a device capability tracker circuit. In operation, the adaptive enumeration controller controls communication between at least one of the plurality of hosts and one or more PCIe devices based on a first configuration information read from the one or more PCIe devices and a second configuration information stored in the memory.

According to one aspect, a method includes steps of: (1) reading, by an adaptive enumeration controller within a PCIe switch, data from a rules table and loading the data read from the rules table into a non-transitory storage medium, the rules table comprising a linked list of filter criteria and transport operations, respective filter criteria paired with corresponding transport operations, (2) attaching a PCIe device to the PCIe switch, the PCIe switch coupled to at least one host, (3) enumerating the PCIe device, monitoring a configuration read request sent to the attached PCIe device, receiving and monitoring a data packet at the PCIe switch and comparing configuration information in the data packet with the filter criteria to generate a comparison result, (4) storing device capability information in a device capability tracker circuit, (5) retrieving a device capability from the device capability tracker circuit, and (6) processing data transmissions between the PCIe device and the host based on the comparison result.

### BRIEF DESCRIPTION OF THE DRAWINGS

FIG. 1 illustrates one of various examples of a system for adaptive enumeration of PCIe devices.

FIG. 2 illustrates a method of adaptive enumeration of PCIe devices.

### DETAILED DESCRIPTION

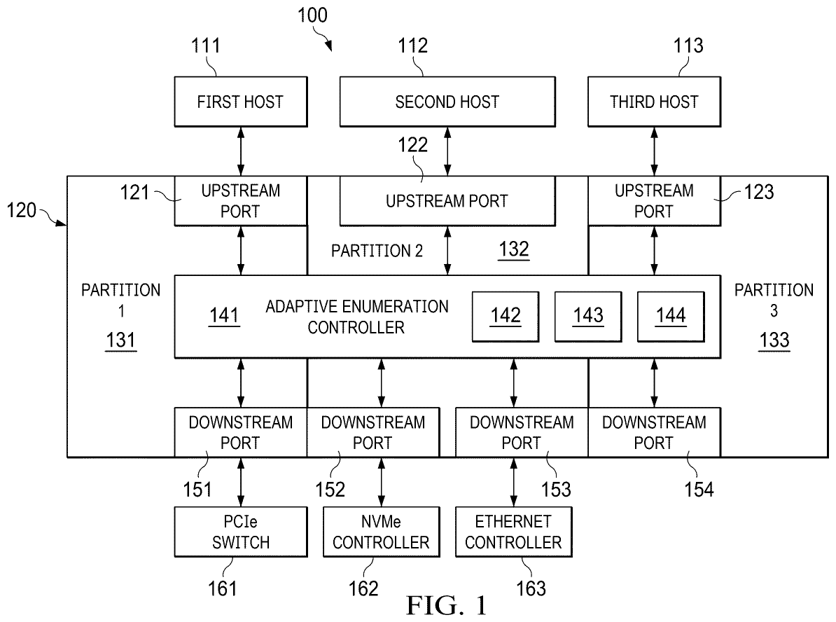

FIG. 1 illustrates one of various examples of a system 100 for adaptive enumeration of PCIe devices.

System 100 may include a first host 111, a second host 112 and a third host 113. The example of FIG. 1 includes three hosts, but this is not intended to be limiting.

First host 111 may be coupled to first PCIe switch 120 at first upstream port 121. First upstream port 121 may also be termed an ingress port and may be identified by a port address. First host 111 and first PCIe switch 120 may communicate via the PCIe communication protocol. Communication between first host 111 and first PCIe switch 120 may include, without limitation, memory read requests, memory write requests, input/output (I/O) read requests, I/O write requests, configuration read requests, configuration write requests, completion packets, and interrupt messages.

Second host 112 may be coupled to first PCIe switch 120 at second upstream port 122. Second upstream port 122 may also be termed an ingress port and may be identified by a port address. Second host 112 and first PCIe switch 120 may communicate via the PCIe communication protocol. Communication between second host 112 and first PCIe switch 120 may include, without limitation, memory read requests, memory write requests, input/output (I/O) read requests, I/O write requests, configuration read requests, configuration write requests, completion packets, and interrupt messages.

Third host 113 may be coupled to first PCIe switch 120 at third upstream port 123. Third upstream port 123 may also be termed an ingress port and may be identified by a port address. Third host 113 and first PCIe switch 120 may communicate via the PCIe communication protocol. Communication between third host 113 and first PCIe switch 120 may include, without limitation, memory read requests, memory write requests, input/output (I/O) read requests, I/O write requests, configuration read requests, configuration write requests, completion packets, and interrupt messages.

First PCIe switch 120 may be configured to include multiple partitions. In the example illustrated in FIG. 1, first PCIe switch 120 includes three partitions, a first partition 131, a second partition 132 and a third partition 133, but this is not intended to be limiting.

First partition 131 may include first upstream port 121. First upstream port 121 may enable communication between first PCIe switch 120 and first host 111. First partition 131 may include first downstream port 151. First downstream port 151 may also be termed an egress port and may be identified by a port address. First partition 131 may be coupled to adaptive enumeration controller 141.

Second partition 132 may include second upstream port 122. Second upstream port 122 may enable communication between first PCIe switch 120 and second host 112. Second partition 132 may include second downstream port 152 and third downstream port 153. Second downstream port 152 may also be termed an egress port and may be identified by a port address. Third downstream port 153 may also be termed an egress port and may be identified by a port address. Second partition 132 may be coupled to adaptive enumeration controller 141.

Third partition 133 may include third upstream port 123. Third upstream port 123 may enable communication between first PCIe switch 120 and third host 113. Third partition 133 may include fourth downstream port 154. Fourth downstream port 154 may also be termed an egress port and may be identified by a port address. Third partition 133 may be coupled to adaptive enumeration controller 141.

The example illustrated in FIG. 1 includes three hosts, three upstream ports, and four downstream ports, but this is not intended to be limiting. Other examples may include a different number of hosts, upstream ports and downstream ports. Respective partitions may include one upstream port, and may include one downstream port or multiple downstream ports.

Adaptive enumeration controller 141 may include memory 142. Memory 142 may be a non-transitory storage medium within system 100. Memory 142 may be part of adaptive enumeration controller 141 or may be otherwise part of system 100. Adaptive enumeration controller 141 may include rules table 143. Adaptive enumeration controller 141 may include device capability tracker circuit 144. In operation, adaptive enumeration controller 141 may read data from a rules table 143 and may load the data from rules table 143 into memory 142. Rules table 143 may be a stored in hardware or may be generated as part of a software program. Data in rules table 143 may be a linked list, the linked list including pairs of filter criteria and transport operations. Each filter criteria may be paired with a corresponding transport operation. When a respective filter criteria is matched, the corresponding transport operation may be implemented. As one of various examples, the filter criteria may include device IDs of PCIe device, and the transport operations may include a set of data operations, including but not limited to allowing a data transfer, blocking a data transfer and modifying a data transfer. In operation, a PCIe device with a device ID matching a filter criterion with a respective transport operation of allowing data transfer may be allowed to attach to first host 111. A PCIe device with a device ID matching a filter criterion with a respective transport operation of blocking data transfer may be prevented from attaching to first host 111. A PCIe device with a device ID matching a filter criterion with a respective transport operation of modifying data transfer may be attached to first host 111 allowing data transfer with modification. In one of various examples, a transport operation may include data which represents allowing data transmission. In one of various examples, a transport operation may include data which represents preventing data transmission. In one of various examples, a transport operation may include data which represents modifying data transmission.

In one of various examples, rules table 143 may be a 2-column array of dimension N-by-2, where N represents a number of rows of data. Each row may include a first column including at least one filter criteria, including but not limited to a device ID, a vendor ID, a class code or other information not specifically mentioned. Each row may include a second column including at least one transport operation, including but not limited to allowing transmission, blocking transmission and allowing transmission with modification. The filter criteria and transport operation at a row of rules table 143 may represent a data pair.

Filter criteria may include at least one of a source address of the data packet, a destination address of the data packet, an ingress port address of the data packet, an egress port address of the data packet, a configuration register address, a configuration register datum, and a device capability identifier.

Transport operations comprising at least one of a pass-through operation, modifying the data packet from host to device, modifying the data packet from device to host, preventing transmission, and returning an error condition. Pass-through operation may also be termed allowing data transmission.

Adaptive enumeration controller 141 may include device capability tracker circuit 144. Device capability tracker circuit 144 may store data based on PCIe device capabilities. Data stored in device capability tracker circuit 144 may include a device capability identifier. In operation, during enumeration of a PCIe device attached to first PCIe switch 120, device capability tracker circuit 144 may store device capability ID data associated with the PCIe device. In operation, data stored in device capability tracker 144 may be used in preventing, allowing or modifying data transmission between the host and the PCIe device. Data transmission between the host and the PCIe device may include device capabilities of the PCIe device.

In operation, one or more PCIe device may attach to first PCIe switch 120. When the one or more PCIe devices attach to first PCIe switch 120, configuration information may be read from the one of more PCIe devices. One of first host 111, second host 112 and third host 113 may send a plurality of configuration read requests to the one or more PCIe devices attached to first PCIe switch 120, the communication between the host and the PCIe devices may be monitored by the adaptive enumeration controller 141. Configuration information read from the one or more PCIe devices attached to first PCIe switch 120 may be a first configuration information. First configuration information may include a device ID, a vendor ID, a class code or other information not specifically mentioned.

In operation, one of first host 111, second host 112 and third host 113 may configure first PCIe switch 120. Data from rules table 143 may be loaded into memory 142. Data from rules table 143 stored in memory 142 may include filter criteria and transport operations. Data from rules table 143 stored in memory 142 may be second configuration information. Second configuration information may include a filter criteria corresponding to a device ID or another type of unique identifier assigned to a PCIe device. Second configuration information may include filter criteria corresponding to a vendor ID. Second configuration information may include filter criteria corresponding to a class code, the class code specifying a group of similar devices, including but not limited to network controllers, memory controllers, display controllers, system peripherals, input devices, and graphics adapters. Second configuration information may include transport operations corresponding to data operations allowed by first PCIe switch 120. Transport operations may include allowing data transmission, blocking data transmission and modifying data transmission.

In operation, second PCIe switch 161 may be coupled to first downstream port 151. Second PCIe switch 161 may be a hardware component physically coupled to first PCIe switch 120. Second PCIe switch 161 may be a hardware component coupled to first PCIe switch 120 over a wireless communication protocol. In the example illustrated in FIG. 1, second PCIe switch 161 may be coupled to first downstream port 151, but this is not intended to be limiting. In other examples, other PCIe devices may be coupled to first downstream port 151.

Second PCIe switch 161 may communicate with first host 111. During enumeration, first host 111 may send a plurality of configuration read requests to second PCIe switch 161 and first configuration information may be read from second PCIe switch 161, the communication between first host 111 and the second PCIe switch 161 may be monitored by adaptive enumeration controller 141. Adaptive enumeration controller 141 may compare first configuration information read from second PCIe switch 161 with second configuration information in memory 142. If first configuration information read from second PCIe switch 161 matches a filter criteria of the second configuration information stored in memory 142, first PCIe switch 120 may implement the associated transport operation stored in memory 142. As one of various examples, first configuration information may include a device ID A, and second configuration information may include a data pair comprising a filter criteria of device ID A, and a transport operation comprising allowing data transmission. First PCIe switch 120 may allow second PCIe switch 161 to communicate with first host 111 based on the comparison indicating that second PCIe switch 161 includes first configuration information including device ID A, and memory 142 contains filter criteria and transport operations indicating that device ID A is allowed to communicate. In this manner, first PCIe switch 120 may control communication within system 100.

In operation, Non-Volatile Memory Express (NVMe) controller 162 may be coupled to second downstream port 152. NVMe controller 162 may be part of a hardware component physically coupled to first PCIe switch 120. NVMe controller 162 may communicate with first PCIe switch 120 over a wireless communication protocol. In the example illustrated in FIG. 1, NVMe controller 162 may be coupled to second downstream port 152, but this is not intended to be limiting. In other examples, other PCIe devices may be coupled to second downstream port 152.

NVMe controller 162 may communicate with second host 112 via second downstream port 152. During enumeration, second host 112 may send a plurality of configuration read requests to NVMe controller 162 and first configuration information may be read from NVMe controller 162, the communication between second host 112 and NVMe controller 162 may be monitored by the adaptive enumeration controller 141. Adaptive enumeration controller 141 may compare first configuration information read from NVMe controller 162 with second configuration information in memory 142. If first configuration information read from NVMe controller 162 matches a filter criteria of the second configuration information stored in memory 142, first PCIe switch 120 may implement the associated transport operation stored in memory 142 at the location of the matching filter criteria. As one of various examples, one row of memory 142 may include a filter criteria of a device ID, and this device ID may match the device ID of the first configuration information read from NVMe controller 162, and the transport operation stored at the same row of memory 142 may be implemented by first PCIe switch 120.

As one of various examples, first configuration information may include a device ID B, and second configuration information may include a data pair comprising a filter criteria of device ID B, and a transport operation comprising allowing data transmission. First PCIe switch 120 may allow NVMe controller 162 to communicate with second host 112 based on the comparison indicating that first configuration information from NVMe controller 162 includes device ID B, and memory 142 contains filter criteria and transport operations indicating that device ID B is allowed to communicate. In this manner, first PCIe switch 120 may control communication within system 100.

As one of various examples, first configuration information may include a device ID C, and second configuration information may include a data pair comprising a filter criteria of device ID C, and a transport operation comprising the blocking of data transmission. First PCIe switch 120 may block NVMe controller 162 from communication with second host 112 based on the comparison indicating that first configuration information from NVMe controller 162 includes device ID C, and memory 142 contains filter criteria and transport operations indicating that device ID C is blocked from communication. In this manner, first PCIe switch 120 may control communication within system 100.

The examples of device ID A, device ID B and device ID C are not intended to be limiting. Other examples may include other device IDs, or may include a vendor ID, a class code, or another filter criteria.

In operation, Ethernet controller 163 may be coupled to third downstream port 153. Ethernet controller 163 may be part of a hardware component physically coupled to first PCIe switch 120. Ethernet controller 163 may communicate with first PCIe switch 120 over a wireless communication protocol. In the example illustrated in FIG. 1, Ethernet controller 163 may be coupled to third downstream port 153, but this is not intended to be limiting. In other examples, other PCIe devices may be coupled to third downstream port 153.

Ethernet controller 163 may communicate with second host 112 via third downstream port 153. During enumeration, second host 112 may send a plurality of configuration read requests and may read first configuration information from Ethernet controller 163, the communication between second host 112 and Ethernet controller 163 may be monitored by the adaptive enumeration controller 141. Adaptive enumeration controller 141 may compare first configuration information read from Ethernet controller 163 with second configuration information in memory 142. If first configuration information read from Ethernet controller 163 matches a filter criteria of the second configuration information stored in memory 142, first PCIe switch 120 may implement the associated transport operation stored in memory 142 at the location of the matching filter criteria. As one of various examples, one row of memory 142 may include a filter criteria of a particular device ID, and this particular device ID may match the particular device ID of the first configuration information read from Ethernet controller 163, and the transport operation stored at the same row of memory 142 may be implemented by first PCIe switch 120.

In one of various examples, first configuration information read from Ethernet controller 163 may include one or more class codes, respective class codes identifying a class of devices, the class of devices including Ethernet controllers. As one of various examples, one row of memory 142 may include a filter criteria of a class code of Ethernet controller 163, and this class code may match the class code of the first configuration information read from Ethernet controller 163, and the transport operation stored at the same row of memory 142 may be implemented by first PCIe switch 120.

In one of various examples, first PCIe switch 120 may implement security protocols and prevent unapproved devices from communicating with first PCIe switch 120. In other examples, first PCIe switch 120 may be used in an automotive application or in a consumer electronics application to prevent components from unapproved vendors from communicating with at least one of first host 111, second host 112 and third host 113.

As described and illustrated in reference to FIG. 1, system 100 enables an adaptive enumeration of PCIe devices, allowing access to first PCIe switch 120 and preventing access to at least one of first host 111, second host 112 and third host 113 based on first configuration information read from a PCIe device and second configuration information stored in a memory.

In one of various examples, system 100 may be an Advanced Driver Assistance System (ADAS) and first PCIe switch 120 may control communication between one or more hosts and one or more external components, including but not limited to graphics processing units, artificial intelligence (AI) accelerators, radar and lidar controllers, Network Interface Cards (NICs), storage devices, optical sensors and infotainment system controllers.

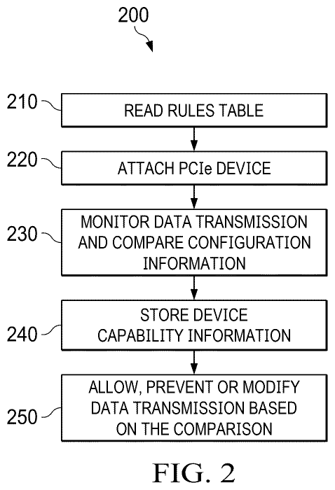

FIG. 2 illustrates a method of adaptive enumeration of PCIe devices.

At operation 210, a PCIe switch may read data from a rules table and load the data from the rules table into a memory. The data may be read by an adaptive enumeration controller, or may be read by another circuit component or software component. The memory may be a non-transitory storage medium.

The rules table may be a linked list of filter criteria and transport operations, respective filter criteria paired with respective transport operations. As one of various examples, the rules table may be a 2-column array of dimension N-by-2, where N represents a number of rows of data. Each row may include a first column including filter criteria, including but not limited to a device ID, a vendor ID, a class code, a source address of a data packet, a destination address of a data packet, an ingress port address of the data packet, an egress port address of the data packet, a configuration register address, a configuration register datum, a device capability identifier, or other information not specifically mentioned. Each row may include a second column including at least one transport operation, including but not limited to allowing transmission, blocking transmission, returning an error condition, and allowing transmission with modification. A filter criteria and transport operation in one row of memory may comprise a data pair.

At operation 220, a PCIe device may be attached to the PCIe switch. The PCIe switch may be coupled to at least one host.

At operation 230, the at least one host may enumerate the attached PCIe device and may send at least one configuration read request to the attached PCIe device, and may receive a data packet from the attached PCIe device including at least a configuration information, data transmission between the host and the PCIe device may be monitored by an adaptive enumeration controller. In one of various examples, the adaptive enumeration controller may be adaptive enumeration controller 141 as described and illustrated in reference to FIG. 1. The configuration information from the attached PCIe device may be compared with filter criteria stored in the memory.

At operation 240, device capability information may be stored in a device capability tracker circuit. The device capability tracker circuit may be a hardware component or may be a software component.

At operation 250, data transmissions between the host and the attached PCIe device may be allowed, prevented or modified based on the comparison.

As one of various examples, configuration information may match with filter criteria based on a device ID, and the memory entry matching the filter criteria may include a transport operation, the transport operation to indicate that data transmissions between the attached PCIe device and the host are not allowed. Data transmissions between the attached PCIe device and the host may be blocked.

As one of various examples, configuration information may match with filter criteria based on a vendor ID, and the memory entry matching the filter criteria may include a transport operation to indicate that data transmissions between the attached PCIe device and the host are allowed based on the vendor ID indicating the attached PCIe device is provided by an approved vendor. Data transmissions between the attached PCIe device and the host may be allowed. Data transmissions may pass through from the attached PCIe device and the host and from the host to the attached PCIe device.

As one of various examples, configuration information may match with filter criteria based on a class code, and the memory entry matching the filter criteria may include a transport operation to indicate that data transmissions between the attached PCIe device and the host to be modified. Data transmissions between the attached PCIe device and the host may be allowed. Data transmissions between the attached PCIe device and the host may be modified based on information stored in the memory.

During transmission of data packets from the attached PCIe device to a host, via the PCIe switch, hardware configurations may be modified to capture a completion response. Hardware configurations may be reverted to a previous state after the completion response is received.

1. A system comprising:
a PCIe switch coupled to a plurality of hosts, the PCIe switch comprising:
a plurality of partitions, respective partitions comprising at least one upstream port and at least one downstream port;
an adaptive enumeration controller coupled to the plurality of partitions, the adaptive enumeration controller comprising a memory, a rules table and a device capability tracker circuit; and
the adaptive enumeration controller to control communication between at least one of the plurality of hosts and one or more PCIe devices based on a first configuration information read from the one or more PCIe devices and a second configuration information stored in the memory.

2. The system as claimed in claim 1, the adaptive enumeration controller to read data from the rules table and to store the data read from the rules table in the memory.

3. The system as claimed in claim 1, the second configuration information stored in the memory comprising a linked list, the linked list including columns of filter criteria and columns of transport operations.

4. The system as claimed in claim 3, the filter criteria comprising at least one of a device ID, a vendor ID, a class code, a source address of the data packet, a destination address of the data packet, an ingress port address of the data packet, an egress port address of the data packet, a configuration register address, a configuration register datum, and a device capability identifier.

5. The system as claimed in claim 4, the transport operations comprising at least one of allowing data transmission, blocking data transmission and modifying data transmission.

6. The system as claimed in claim 5, the adaptive enumeration controller to allow the at least one of the plurality of hosts to communicate with the one or more PCIe devices based on a filter criteria in the first configuration information matching a filter criteria in the second configuration information and the corresponding transport operation representing allowing transmission.

7. The system as claimed in claim 5, the adaptive enumeration controller to prevent the at least one of the plurality of hosts from communicating with the one or more PCIe devices based on the filter criteria in the first configuration information matching the filter criteria in the second configuration information and the corresponding transport operation representing blocking transmission.

8. The system as claimed in claim 5, the adaptive enumeration controller to modify the communication between at least one of the plurality of hosts and the one or more PCIe devices based on the filter criteria in the first configuration information matching the filter criteria in the second configuration information and the corresponding transport operation representing modifying transmission.

9. The system as claimed in claim 1, the first configuration information read from the one or more PCIe devices comprising at least one of a device ID, a vendor ID, a class code, a source address of the data packet, a destination address of the data packet, an ingress port address of the data packet, an egress port address of the data packet, a configuration register address, a configuration register datum, and a device capability identifier.

10. The system as claimed in claim 1, the one or more PCIe devices comprising an Ethernet controller.

11. The system as claimed in claim 1, the PCIe switch comprising a PCIe switch in an Advanced Driver Assistance System (ADAS).

12. The system as claimed in claim 1, the PCIe devices comprising one or more Non-Volatile Memory Express (NVMe) memory components and one or more Network Interface Cards (NICs).

13. A method comprising:
reading, by an adaptive enumeration controller within a PCIe switch, data from a rules table and loading the data read from the rules table into a non-transitory storage medium, the rules table comprising a linked list of filter criteria and transport operations, respective filter criteria paired with corresponding transport operations;
attaching a PCIe device to the PCIe switch, the PCIe switch coupled to at least one host;
enumerating the PCIe device, monitoring a configuration read request sent to the attached PCIe device, receiving and monitoring a data packet at the PCIe switch and comparing configuration information in the data packet with the filter criteria to generate a comparison result;
storing device capability information in a device capability tracker circuit;
retrieving a device capability from the device capability tracker circuit; and
processing data transmissions between the PCIe device and the host based on the comparison result.

14. The method as claimed in claim 13, the processing data transmissions between the PCIe device and the host comprising at least one of: allowing the data transmission, modifying the data transmission, and preventing the data transmission.

15. The method as claimed in claim 13, the configuration information in the data packet comprising at least one of a source address of the data packet, a destination address of the data packet, an ingress port address of the data packet, an egress port address of the data packet, a configuration register address, a configuration register datum, and a device capability identifier.

16. The method as claimed in claim 13, the filter criteria comprising at least one of a source address of the data packet, a destination address of the data packet, an ingress port address of the data packet, an egress port address of the data packet, a configuration register address, configuration register data, and a device capability identifier.

17. The method as claimed in claim 13, the transport operations comprising at least one of a pass-through operation, modifying the data packet from host to device, modifying the data packet from device to host, preventing data transmission, and returning an error condition.

18. The method as claimed in claim 13, at least one transport operation comprising a combination of at least two of: a pass-through operation, modifying the data packet from host to device, modifying the data packet from device to host, preventing transmission of the data packet, and returning an error condition.

19. The method as claimed in claim 18, the at least one transport operation to be applied to matching data packets among subsequent data packets.

20. The method as claimed in claim 13, the processing data transmissions to allow communication between a host and the PCIe device based on a destination address of the data packet matching a filter criteria and a transport operation comprising a pass-through operation.

21. The method as claimed in claim 13, the processing data transmissions to prevent communication between the host and the PCIe device based on a destination address of the data packet matching a filter criteria and a transport operation comprising preventing transmission.

22. The method as claimed in claim 13, the processing data transmissions to modify communication from the host to the PCIe device based on a configuration register address of the data packet matching a filter criteria and a transport operation comprising a modifying the data packet from host to device.

23. The method as claimed in claim 13, the processing data transmissions to modify communication from the PCIe device to the host based on a configuration register data of the data packet matching a filter criteria and a transport operation comprising a modifying the data packet from device to host.
